(19) United States
(12) Patent Application Publication
(10) Pub. No.: US 2026/0004496 A1
(43) Pub. Date: Jan. 1, 2026

(54) CHARACTER LOCOMOTION ANIMATION SET GENERATION

(71) Applicant: Unity Technologies SF, San Francisco, CA (US)

(72) Inventors: Florent Benjamin Bocquelet, Chambéry (FR); Félix Gingras Harvey, Montréal (CA); Pierre-Luc Loyer, Montréal (CA)

(21) Appl. No.: 18/755,640

(22) Filed: Jun. 26, 2024

(51) Int. Cl. G06T 13/40; A63F 13/57

(52) U.S. Cl. CPC G06T 13/40; A63F 13/57

(57) ABSTRACT

A method of generating a locomotion set for a character is disclosed. One or more text inputs specifying movement style and base locomotion speed are received. A forward motion clip is generated using a first model. The first model transforms a noisy sequence into a denoised, prompt-following motion with predicted foot contact states. The forward motion clip is extended to one or more additional motion clips via a second model. The second model synchronizes the one or more additional motion clips to cover multiple directions based on the one or more text inputs. The locomotion set is adjusted based on one or more user interactions.

### TECHNICAL FIELD

The subject matter disclosed herein generally relates to the technical field of character animation within 3-dimensional computer games, and, in one specific example, to computer systems and methods for character locomotion animation set generation assisted by artificial intelligence (AI).

### BACKGROUND

In 3D gaming, character locomotion animation is important for realism and player immersion. Traditionally, these animations are created through labor-intensive processes such as motion capture or manual keyframe animation. Motion capture, while realistic, is costly and requires significant post-processing to align with game dynamics. Manual animation, though flexible, demands extensive time and expertise. Both methods necessitate meticulous synchronization across various movement directions and speeds to ensure smooth gameplay transitions, significantly increasing development complexity.

Existing tools that automate parts of the animation process do not fully address the initial creation of animations and lack integration with advanced technologies that could streamline these tasks. This gap can lead to smaller developers relying on pre-made animation sets, which may compromise game originality and restrict customization.

More efficient animation processes are needed that reduce cost, time, and/or technical barriers while maintaining high-quality, customizable character animations.

### BRIEF DESCRIPTION OF THE DRAWINGS

Features and advantages of example embodiments of the present disclosure will become apparent from the following detailed description, taken in combination with the appended drawings, in which:

FIG. 1 is a block diagram illustrating example modules of a system for character locomotion animation set generation;

FIG. 2 is a block diagram illustrating an example method of character locomotion animation set generation;

FIGS. 3A-3C are screenshots depicting a result of applying the ControlNet module of FIG. 2 to generate motions for multiple directions.

FIGS. 4A-4B are a series of screenshots depicting example user interfaces for modifying a prompt.

FIGS. 5A, 5B, 5C, and 5D depict a hierarchical sequence of nested graphs, each progressively refining and extending the locomotion animation generation process, from initial parameter configuration and motion data processing to detailed synthesis and final optimization of character movements.

FIG. 6 is a block diagram illustrating an example software architecture, which may be used in conjunction with various hardware architectures described herein, in accordance with one or more example embodiments; and

FIG. 7 is a block diagram illustrating components of a machine, according to some example embodiments, configured to read instructions from a machine-readable medium (e.g., a machine-readable storage medium) and perform any one or more of the methodologies discussed herein, in accordance with one or more example embodiments.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the disclosed subject matter. It will be evident, however, to those skilled in the art, that various embodiments of the disclosed subject matter may be practiced without these specific details.

Some 3D games contain animated characters. For example, some 3D games may include an animated protagonist (main character) controlled by the player. In third-person games, the main character may be partially or fully visible by the player and its full body must be animated. One of the mechanics of a 3D game may be player movement, or locomotion, in order for the main character to move in the 3D space.

Animations may be created to convey the player movement in a realistic fashion so that the speed and direction of the character matches its animated locomotion. Development of the 3D game may therefore include authoring of animation clips that will be used as a basis of character locomotion. Such clips may be designed to convey the movement in different directions, and may be temporally synchronized (e.g., at the level of feet contacting the ground (contacts)) so that blending clips together between different directions leads to a smooth continuous motion with valid ground contacts. Such clips may also be “loopable” (e.g., the pose of the character on the last frame of the animation may end up the same as on the first frame of the animation so that looping the animation does not lead to flickering on each loop).

Such sets of clips used to populate a blend tree used in a character controller may be referred to as a “locomotion set”. A locomotion set may contain clips for a single speed (e.g., a walking speed), but can also contain clips for multiple speeds (e.g., walk, jog, run). In the latter case, the locomotion subsets corresponding to different speeds may also be “synchronized” at the contact level, up to a temporal scaling factor, to allow smooth blending between different speeds. A typical 3-speed locomotion set may therefore contain 8×3=24 locomotion clips, often with an additional “Idle” clip.

In example embodiments, “synchronization” may refer to one or more of (1) animation length and speed or (2) contact timings, which allow the system to blend between clips without foot sliding.

In example embodiments, contact timing synchronization is possible because the system's models can accept contact states (noisy or clean) as inputs. These contact states can be extracted from the first model outputs or extracted automatically by another automated process. The system supports both. In example embodiments, path following is another dimension of the problem that is addressed.

In example embodiments, such locomotion clips may rely either on (1) long manual post-processing and cleaning of Motion Capture (MOCAP) sequences, ensuring contact synchronization, and correct following of the desired directions or (2) manually authoring of such motions from scratch in specialized software. Because these options may require a lot of time and manual effort, some (e.g., smaller) development teams may choose to buy pre-made “locomotion sets” to use in their game, requiring monetary investments.

In example embodiments, the system and methods disclosed herein drastically accelerate and simplify the authoring of such locomotion sets (e.g., by generating 8-way locomotion clips that are contact-synchronized and follow desired directions, with minimal user inputs).

Motion Capture usually yields very high quality animations, but is very expensive and requires lots of planning and manual post-processing in order to format and synchronize motion segments into usable locomotion clips.

In Digital Content Creation (DCC) software, such as Maya or Blender, artists can create animations from scratch. This usually is highly time consuming and requires a high level of expertise. It can also impose a lot of duplicated work to modify a base motion into compatible locomotion clips.

Plugins for DCCs, can greatly accelerate the post-processing, duplication, and/or synchronization of animations in order to generate valid locomotion sets. However, they do not tackle the first authoring pass (starting from scratch) and are not machine-learning based approaches, so they do not implicitly impose any realistic motion prior on their outputs. A number of user interactions and motion manipulation are still required to use these plugins. These particular tools also do not provide any text-based conditioning capabilities nor are they probabilistic: particular inputs always lead to the same outputs without variation.

The disclosed system offers one or more of the following technological improvements to the technological problems with prior art systems:

a) Starting from Scratch

The disclosed system and methods allow a user to start without existing motion/MOCAP to start developing the locomotion set. There is no need to purchase a base motion pack, or to modify the speed/duration of existing clips.

### b) Minimal Inputs

The manual labor required by the disclosed systems and methods is minimal. From a few user inputs, the locomotion set can be completely generated, yielding synchronized, looping, blend-ready clips.

### c) Text Conditioning

The disclosed system and methods support text-conditioning as a way for users to define the style or type of movement that is expected in the locomotion clips.

### d) Data-Driven

The disclosed system and methods leverage machine learning models to produce realistic motions, as opposed to other mathematical approaches that do not enforce “plausibility” as a constraint.

### e) Sampling Capabilities

The disclosed system and methods support generating infinite variants of a locomotion set from fixed inputs, allowing users to explore the space of plausible locomotion respecting their constraints.

In example embodiments, a complete locomotion set is generated from minimal inputs, with no manual editing of the motions required.

In example embodiments, a sequence of processing steps and transformations are used to generate the complete locomotion set from the inputs.

In example embodiments, one or more of the processing steps leverage a custom machine-learning model to generate, edit, or postprocess motions.

In example embodiments, resulting motion clips respect one or more constraints needed to be compatible with one or more animation controller setups (e.g., with respect to contact synchronization, looping, path following, speed, etc.).

The development of character locomotion animations in 3D games presents several technological challenges that impact efficiency, cost, and/or realism. These challenges include:

High Resource and Time Requirements: Traditional methods such as motion capture (MOCAP) and manual keyframe animation are resource-intensive. MOCAP requires significant financial investment and extensive post-processing to align animations with game dynamics. Manual animation demands a high level of expertise and substantial time investment, making these methods less accessible for smaller development teams.

Lack of Flexibility and Customization: Purchasing pre-made locomotion sets, while less resource-intensive, limits developers' ability to customize animations to fit specific game dynamics and styles. This can compromise the originality and appeal of games.

Complexity in Synchronization and Looping: Ensuring that animations are loopable and synchronized across various movement directions and speeds is crucial for smooth gameplay transitions. This synchronization is complex and often manually intensive, increasing the likelihood of errors such as sliding feet when animations are blended.

The disclosed system and methods provide several technological solutions to these technological problems by, for example, leveraging advanced machine learning techniques and/or real-time processing capabilities:

AI-Assisted Animation Generation: Utilizing AI models, specifically diffusion models adapted from image processing technologies, the generation of high-quality locomotion animations is automated from minimal inputs. This approach reduces the time and expertise required compared to traditional methods.

Real-Time Interactive Control and Updates: In example embodiments, real-time updates and interactive control over the animation generation process are allowed. For example, users can modify animation prompts live and see updates quickly, enhancing the flexibility and customization of the animation sets.

Automated Synchronization and Looping: Generated animations are synchronized at the contact level and are loopable by default. This automation reduces the complexity and manual effort involved in creating smooth and realistic animations.

Integration and Scalability: The disclosed system is configured to integrate seamlessly into existing game development workflows. It also provides options to customize and scale the animation sets according to developer needs.

Feedback and Future Adaptability: Feedback mechanisms ensure that the system remains adaptable and responsive to user needs and technological advancements.

The development of character locomotion animations in 3D gaming environments presents significant technological challenges, particularly in terms of resource allocation, flexibility, and/or synchronization. The disclosed system and methods are configured to address these challenges (e.g., by leveraging machine learning to enhance the efficiency and effectiveness of animation generation processes).

In example, the system is configured for control and updates at interactive rates during development. This allows developers to make live adjustments to animation prompts, with quick visualization of the results. This is facilitated by a backend architecture that supports dynamic interaction with machine learning models, specifically utilizing diffusion models similar to those employed in advanced image generation technologies. These models are adept at processing complex data inputs to generate detailed and contextually appropriate animations that are loopable and synchronized.

In example embodiments, the disclosed system and methods automate the synchronization of animations across multiple directions and speeds. One or more sophisticated algorithms are employed that extract and/or utilize contact states from a base ‘forward motion’ animation to ensure that subsequent animations maintain consistent contact points, thereby preventing the common issue of sliding feet during gameplay transitions. This synchronization is important for maintaining the realism and fluidity of character movements within the game environment.

Furthermore, the future enhancements and integrations are accommodated based on user feedback and evolving technological standards. This adaptability helps for maintaining the relevance and utility of the system in a rapidly changing technological landscape.

Existing gaps in the animation generation process are addressed by reducing the need for extensive manual input and specialized expertise. Additionally, flexibility and at least near real-time capabilities of animation tools available to developers are enhanced. By integrating cutting-edge machine learning models with a user-friendly interface that supports real-time interactions, the system sets a new standard for the development of complex animation sets in the gaming industry.

The integration of artificial intelligence (AI) in character locomotion animation set generation leverages advanced machine learning techniques to revolutionize the creation of animations in 3D gaming. One or more diffusion models, a type of deep neural network adapted from the field of image generation, are used. These models are particularly effective in generating detailed and contextually appropriate motion animations that enhance the realism and engagement of game characters.

In example embodiments, an AI (e.g., ControlNet) model works in conjunction with the Motion Denoiser, itself a diffusion model. ControlNet may be configured to handle complex inputs, including incomplete motion data and specific control signals. It intelligently completes missing motion segments, ensuring that animations adhere to predefined trajectories and maintain accurate contact timings. This capability may be used for synchronizing foot contacts across different animations, facilitating smooth transitions when characters change directions or speeds within the game environment.

Developers can dynamically adjust animation prompts and visualize the effects, thanks to a robust backend architecture that integrates these AI models seamlessly. This feature not only enhances workflow efficiency but also allows for high degrees of customization and flexibility in animation design.

AI also automates the generation of loopable and blendable animations, maintaining consistent contact points and appropriate looping parameters without manual intervention. This automation extends to the generation of multiple animation variations from fixed inputs, enabling developers to explore a wide range of plausible locomotion styles that conform to the game's aesthetic and functional requirements.

Moreover, the AI-driven system reduces the need for extensive manual labor and specialized animation expertise, making sophisticated animation techniques more accessible to smaller development teams and individual developers. This democratization of animation technology reduces both the time and financial costs associated with traditional animation production, thereby broadening the creative possibilities within the gaming industry.

The disclosed use of AI in character locomotion animation set generation not only streamlines the development process but also significantly enhances the creative capabilities of game developers. By automating complex tasks, enabling at least near real-time customization, and ensuring high-quality outputs, the disclosed AI techniques empower developers to create more dynamic and realistic character animations, thereby elevating the player's experience in 3D games.

In the context of character locomotion animation set generation, the disclosed AI-driven system and techniques do not merely automate the animation process; they fundamentally transform it. For example, the system utilizes AI models, specifically diffusion models and ControlNet, to interpret minimal textual inputs and generate detailed, contextually appropriate motion animations that are inherently synchronized and loopable.

The disclosed system and techniques significantly improve a technical process. In the case of animation, the AI not only automates but also enhances the quality and applicability of the animations in real-time gaming environments. This not only solves the technical problem of creating realistic and adaptable animations efficiently but also introduces a level of flexibility and precision in animation generation that was previously unattainable.

In example embodiments, a method of generating a locomotion set for a character is disclosed. One or more text inputs specifying movement style and base locomotion speed are received. A forward motion clip is generated using a first model. The first model transforms a noisy sequence into a denoised, prompt-following motion with predicted foot contact states. The forward motion clip is extended to one or more additional motion clips via a second model. The second model synchronizes the one or more additional motion clips to cover multiple directions based on the one or more text inputs. The locomotion set is adjusted in at least real-time based on one or more user interactions or game scenario changes.

In example embodiments, generation and/or adjusting of the locomotion set begins with receiving text inputs and progresses through generating and extending motion clips.

Receiving Text Inputs: One or more text inputs specifying movement style and/or base locomotion speed are received. This step sets the parameters for the type of motion to be generated, establishing the initial conditions under which the subsequent motion clips will be created.

Generating a Forward Motion Clip: Using the parameters defined by the text inputs, a forward motion clip is generated. This step includes transforming a noisy sequence into a denoised, prompt-following motion with predicted foot contact states. The generation of this forward motion clip lays the groundwork for creating a basic, directional movement that serves as the template for further motion extensions.

Extending the Forward Motion Clip: The forward motion clip is then extended to additional motion clips via a second model. This step involves synchronizing these additional motion clips to cover multiple directions based on the initial text inputs. By extending the initial forward motion clip, the system creates a comprehensive set of motion clips that provide a full range of directional movements, enhancing the character's ability to move fluidly in the gaming environment.

Adjusting the Locomotion Set in Real-Time: The locomotion set is generated and/or adjusted in real-time based on user interactions or changes in the game scenario. This step ensures that the locomotion set remains relevant and responsive to the evolving art direction of the game. The adjustments made during this step are informed by the initial parameters and the extended set of motion clips. For instance, if the game scenario requires a change in speed or direction, the locomotion set can be dynamically modified to accommodate these changes, ensuring that the character's movements remain synchronized and realistic.

The locomotion set may include a collection of animation clips that are used to control the movement of a character within a 3D environment, such as a video game. This set typically includes animations that depict various speeds and directions of movement, allowing a character to exhibit realistic and fluid motion across different scenarios within the game.

For example, it may be that a character within a game now needs to run at 5 meters per second instead of 3 m/s (e.g., because the director now wants a faster-paced game). This change is easy to accommodate by developers using the system.

In example embodiments, the locomotion set originates from initial user inputs and sophisticated AI-driven models that generate and synchronize multiple motion clips. It can be adjusted continuously to adapt to the dynamic and iterative nature of video game development, ensuring that character animations are both realistic and suited to the art direction.

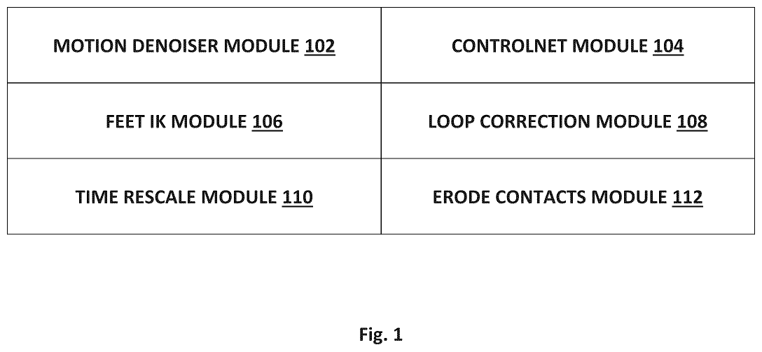

FIG. 1 is a block diagram illustrating example modules of a system for character locomotion animation set generation. In example embodiments, the system includes one or more of the following modules or components:

Motion Denoiser module 102. In example embodiments, the Motion Denoiser module 102 includes a text-to-motion generator that is configured to take as input a text prompt and a noisy motion sequence with a user-defined duration. The noisy sequence can be pure noise, generated by a random process, removing the need to actually provide an input sequence. From these inputs the Motion Denoiser generates a denoised motion following the prompt with the correct duration. In example embodiments, the Motion Denoiser includes a Diffusion model, a particular type of deep neural network trained in a specific way. In example embodiments, the Motion Denoiser is configured to receive, and thus predict, one or more foot contact states. In example embodiments, a special variant of the Motion Denoiser is used to predict one or more looping motions.

ControlNet module 104. In example embodiments, the ControlNet module 104 includes a specialized model that combines the Motion Denoiser 102 with one or more specialized layers to modify the inputs and behavior of the Motion Denoiser 102. In example embodiments, it is used as a separate model from the Motion Denoiser 102. In example embodiments, the ControlNet module 104 includes a motion completion model that is configured to take, additionally to the Motion Denoiser module 102 inputs, a control signal consisting of one or more incomplete motion inputs and a corresponding mask. This ControlNet module 104 may be trained to complete the incomplete missing motion received as input. The input motion may be represented as a combination of the per-frame root (hips) velocities, the global root rotations, the angular root velocity around the UP vector, the local joint rotations, and/or the binary contact states for the contact joints (feet). Any subset of these features and the corresponding binary mask can be used as a control signal for the ControlNet module 104. Specific subsets or combinations of features are used to condition the ControlNet module 104, such as root velocities and/or root velocities combined with contact states. A special variant of the ControlNet module 104 may be configured to predict looping motions.

In example embodiments or alternative embodiments, the ControlNet module 104 may be trained to only complete motion from root trajectories and/or contact states. Or the ControlNet module 104 may be trained on global root positions instead of root velocities.

Feet IK module 106. In example embodiments, the “Feet IK” module 106 is configured to perform one or more post-processing operations, including fixing foot slides in a motion based on available contact information.

Loop Correction module 108. In example embodiments, the Loop Correction module 108 is configured to perform one or more post-processing operations, including ensuring that the first and last keyframe of an animation are exactly or substantially the same at the local-joint rotation level. This post-processing may ensure a smooth correction over time so that the results are still smooth and the correction mostly unnoticeable.

Time rescale module 110. In example embodiments, the “Time rescale” module 110 is configured to perform an operation to temporally downsample or upsample an animation, or an “animation track” (e.g., contact states). This process may require an input time scale and input sequence, and may output the time rescaled sequence.

Erode contacts module 112. In example embodiments, the “Erode contacts” module 112 may be configured to perform an operation that can shorten contact states in a sequence. This can be used for example to translate walking contact states into jogging contact states which are shorter in general, even relative to a cycle length. For example, the right foot might be in contact with the ground 60% of the time during a walk cycle, while only 40% of the time during a jog.

The Motion Denoiser, which may be a diffusion model, may be subjected to an initial training phase where it learns to interpret and refine noisy or less accurate motion data into smoother, more realistic motion sequences. This training may involve processing a wide range of motion data variations, guided by textual prompts and other input parameters, to develop a robust capability to generate base animations that are contextually appropriate yet require further refinement.

In example embodiments, the ControlNet model may engage in a secondary training phase. This model enhances the outputs from the Motion Denoiser by incorporating additional inputs such as incomplete motion data and specific control signals, which may include detailed motion features like root velocities or precise contact timings. The role of ControlNet may be to ensure that these refined animations meet stringent gameplay requirements, such as accurate looping and synchronization, providing a complex, layered learning process where ControlNet adjusts and optimizes the preliminary outputs from the Motion Denoiser.

In example embodiments, the system is configured to discover weaknesses in the models in practical scenarios, and provides outputs enabling these weaknesses to be addressed through training of new variants of the models. In example embodiments, the AI models can be swapped and updated in the (e.g., cloud) backend without change to the user interface or experience beyond the improved outputs.

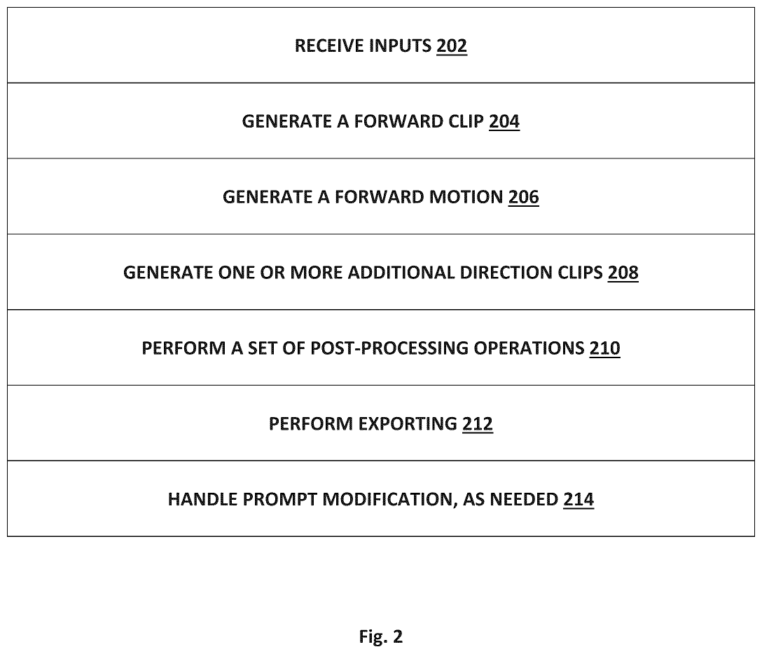

FIG. 2 is a block diagram illustrating an example method of character locomotion animation set generation. In example embodiments, the operations of the method may be performed by one or more of the modules of FIG. 1.

At operation 202, a minimal set of user inputs is received, and a series of operations (processes) are performed, often conditional on previous intermediate outputs, and a complete locomotion set is output in the form of individual motion clips.

At operation 204, one or more of the following inputs are received for a base speed (e.g., a walking speed): text prompt, clip duration (e.g., in frames), locomotion speed (e.g., in m/s), negative prompt, random seed (e.g., a random input for the Motion Denoiser diffusion model).

At operation 206, a “forward” clip is generated. In example embodiments, generation of the forward clip includes generating a “forward spline.” Based on the input speed and duration, the “forward spline” is automatically generated consisting of a straight 2D trajectory in an arbitrary forward direction that has the right length.

In example embodiments, generation of the forward clip includes generating a forward motion. From the spline, a root trajectory on the ground plane is provided to the ControlNet module as a control signal. The ControlNet module then generates the forward locomotion, conditioned on the prompt, the sequence length, and/or the control signal.

At operation 208, one or more (e.g., seven) additional direction clips are generated. In example embodiments, eight directions may be used as a way of covering 360-degree locomotion. However, any number of directions could be used. In example embodiments, the number of the one or more additional directions may be a configurable parameter of the system.

In example embodiments, the process of generating one or more additional direction clips includes extracting contact states from the generated forward motion (e.g., either from the model predictions or with a custom contact detection process).

In example embodiments, the process of generating one or more additional direction clips includes generating splines for each of the additional directions. In example embodiments, the system automatically generates the splines for the other directions based on the input speed and duration. The splines may include straight 2D trajectories in different directions. In total the additional directions may provide a 360-degree total coverage, with each spline being a specific number of degrees apart from its neighbors on each side.

In example embodiments, the process of generating one or more additional direction clips includes combining splines and contacts. For example, each generated trajectory spline may be combined with the extracted contact states to form different control signals.

In example embodiments, the process of generating one or more additional direction clips includes generating direction motions for the additional directions. For example, the ControlNet module is applied to the additional control signals to generate motions that (1) follow the right trajectories and (2) have the same contact times as the forward direction.

In example embodiments, the contact extraction in places may be done directly from the Motion Denoiser module predictions; however, it may also be done by a separate process.

In example embodiments, the locomotion set is generated through a series of computational steps that begin with the input of user-defined parameters. These parameters often include a text prompt describing the desired style or type of movement, and/or a base locomotion speed.

Generating a Forward Motion Clip: Initially, a forward motion clip is created using a Motion Denoiser model. This model processes a noisy input sequence to produce a denoised, coherent motion clip that aligns with the user's specified text prompt, incorporating predicted foot contact states to ensure realistic movement.

Extending the Forward Motion Clip: The forward motion clip is then extended to create additional motion clips that cover various directions of movement. This is typically achieved using a ControlNet model, which synchronizes these additional clips with the forward motion clip, ensuring that all clips are loopable and maintain consistent contact patterns for seamless blending.

The locomotion set is usable for providing dynamic and responsive character animation in video games. It allows characters to move in a lifelike manner, adapting to player commands. The need for adjustment of the locomotion set arises due to several factors:

Interactive Gameplay: Video games are interactive environments where player choices and in-game events can change rapidly. The locomotion set is configured to be adjustable to reflect these changes, ensuring that character movements remain appropriate and responsive to the current gameplay conditions.

Enhanced Realism: Adjusting the locomotion set allows for finer control over the animation details, enhancing the realism of the character's movements. This can include adjustments for different terrains, obstacles, or character interactions within the game.

User Customization: In some games, players may have the ability to customize character traits, including movement styles. Adjusting the locomotion set according to these customizations allows for a more personalized gaming experience.

Game Scenario Changes: As the game progresses, different scenarios may demand different types of movements (e.g., sneaking, sprinting, evading). The locomotion set generator is configured to be flexible to accommodate these scenario-specific requirements.

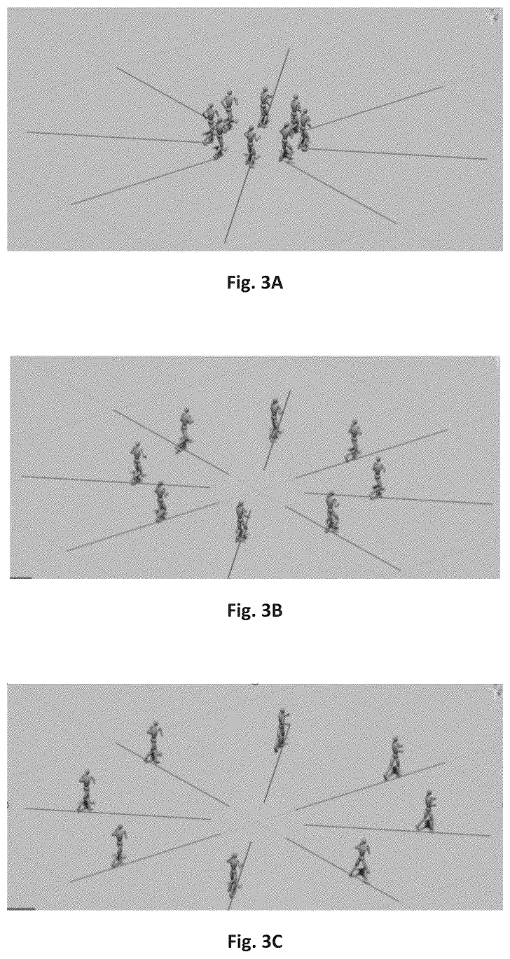

FIGS. 3A-3C are screenshots depicting a result of applying the ControlNet module of FIG. 2 to generate motions for multiple directions. FIG. 3A depicts a screenshot showcasing the initial stage of a generated motion using the ControlNet module. This figure illustrates the baseline output where the character is positioned in a starting pose, ready to initiate movement.

The screenshot captures the character in a neutral stance. This stage sets the foundational parameters for the motion generation.

This figure shows how the AI models interpret and implement the starting conditions of a motion sequence, providing a visual baseline prior to subsequent motions, each of which comes from complete motion sequences that may be generated simultaneously from user inputs.

FIG. 3B presents a screenshot during the mid-sequence of the motion generation, where the character is depicted in an intermediate pose, demonstrating a specific movement such as walking or running.

This screenshot illustrates the dynamic adjustments made by the ControlNet module, showing how the character transitions from the initial pose to a keyframe within the motion sequence. It includes visual cues such as trajectory lines, which are usable for analyzing the motion dynamics and/or ensuring that the movement adheres to the desired path and style.

FIG. 3B shows the application of AI adjustments in real-time, providing insights into the intermediate stages of motion generation and the effectiveness of the AI in maintaining motion fidelity to the user's specifications.

FIG. 3C displays a screenshot at the completion of the motion sequence, where the character reaches the final pose, concluding the movement cycle.

This figure captures the end pose of the character, highlighting the successful execution of a complete motion loop. Looping parameters, such as the seamless transition points that allow the motion to repeat without noticeable disruptions or inconsistencies, are not explicitly shown.

FIG. 3C shows the capability of the AI models to generate a fully functional and loopable animation sequence that meets the end requirements. It serves as a validation of the system's ability to produce end-to-end motion sequences that are both realistic and consistent with the game's dynamics.

At operation 210, one or more post-processing operations are performed. In example embodiments, the performing of the one or more post-processing operations may include overwriting one or more generated root trajectories. For example, the root trajectories of each locomotion clip may be overwritten with a corresponding artificially-created spline trajectory (e.g., to enforce the exact locomotion speed desired).

In example embodiments, there might be one or more slight mismatches between root speed and the rest of the animation, causing sliding artifacts. In this case, in example embodiments, the performing of the one or more post-processing operations may include applying the Motion Denoiser module to each of the animations with the same input prompt and a particular denoising strength so that this model cleans up the motion, making it more cohesive. In example embodiments, the system may only perform a certain percentage (e.g., the last 30%) of the denoising steps in order to preserve the initially-generated content while still allowing the model to correct the sliding issues.

In example embodiments, on each resulting motion from applying the Motion Denoiser module, the Feet IK module may be applied to perform post-processing using the contacts predicted by the denoising model (e.g., in order to correct any minor sliding issue that might be remaining).

In example embodiments, on each resulting motion from applying the Feet IK module, loop-correction may be performed (e.g., to guarantee that the first and last frame of the motion sequence matches). In example embodiments, this may be achieved by gradually dispatching the original difference between the first and last frame over the sequence duration so that it performs a smooth progressive correction toward a perfect match.

In example embodiments, root motion may be removed. For example, on each motion from loop-correction, a process that removes the root translation from the animation (e.g., thus resulting in an in-place animation) may be applied. The gameplay code may be responsible for the actual character speed. If set to the same speed as the user-defined speed, the animation will match the speed, and sliding should not occur. A copy of the forward motion may be stored with the root motion.

At operation 212, exporting is performed. For example, the final locomotion clips are obtained for a desired speed and directions. The clips are ready for use inside a blend tree for an animation controller. The project assets may automatically be updated for those clips without user action.

At operation 214, locomotion sets are generated for different speeds. For example, if a matching locomotion set is desired at a different speed (e.g., jog), but still compatible with the one created in previous operations, those operations may be repeated with the following differences:

Different inputs. The prompt may be modified to reflect a new locomotion speed (e.g., “jogging”). A speed parameter may be updated as needed. A new “Time scale” input may be used to specify how the contact times are defined relative to the base speed.

Contacts from base speed. From the final forward clip with root motion that was stored (e.g., in step 308), contact states are extracted.

Time re-scale. A time rescale may be applied on the contact states obtained using a “Time scale” input.

Erode contacts. An “Erode contact” operation is applied on the contacts obtained.

These new contact states may be combined with information obtained with the new forward spline trajectory to generate the forward locomotion with the new speed.

The rest of the process may be the same as with the base speed, but based on this new forward motion.

If an additional speed is desired (e.g., sprint), the operations may be repeated, with the same exceptions, and leveraging the previous speed's forward motion.

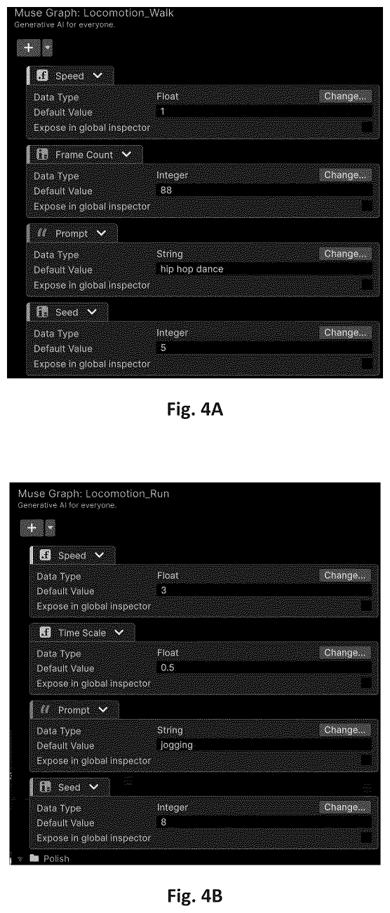

FIGS. 4A-4B are screenshots depicting example user interfaces for modifying a prompt. FIG. 4A provides a visual representation of an initial user interface for modifying animation prompts. This figure includes various text input fields, dropdown menus, and sliders, which users may utilize to input or adjust parameters guiding the animation generation process. The interface is designed to be intuitive, allowing users to easily modify aspects such as the speed or style of the animation. Additionally, it may include a preview area where changes can be immediately visualized, enabling users to iteratively refine their inputs to achieve the desired animation effects. This figure gives an example of the system's user-centric design and its capability to translate textual descriptions into precise animation outputs efficiently.

FIG. 4B extends the depiction of the user interface shown in FIG. 4A by illustrating additional customization options that allow for more detailed control over the animations. The screenshots in FIG. 4B depict one or more advanced settings such as tools for generating a locomotion set that matches another set, such as generating a “jog” set that is in synchronization with a “walk” set.

These interfaces may include sophisticated tools, such as real-time error checking and AI-driven predictive suggestions, which may assist users in creating contextually appropriate and highly refined animations.

Together, FIG. 4A and FIG. 4B effectively demonstrate the depth and flexibility of the AI-driven animation system's user interface. They underscore the system's robustness in accommodating extensive user interactions and its efficacy in facilitating the creation of diverse and dynamic character animations. These figures illustrate how the system supports creative expression and technical precision in animation generation.

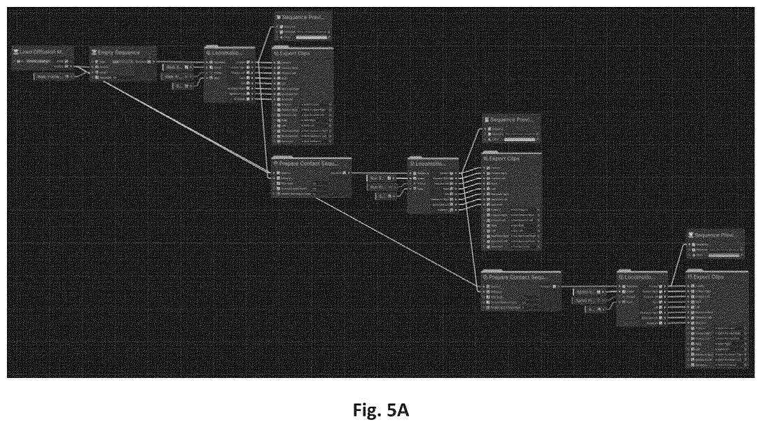

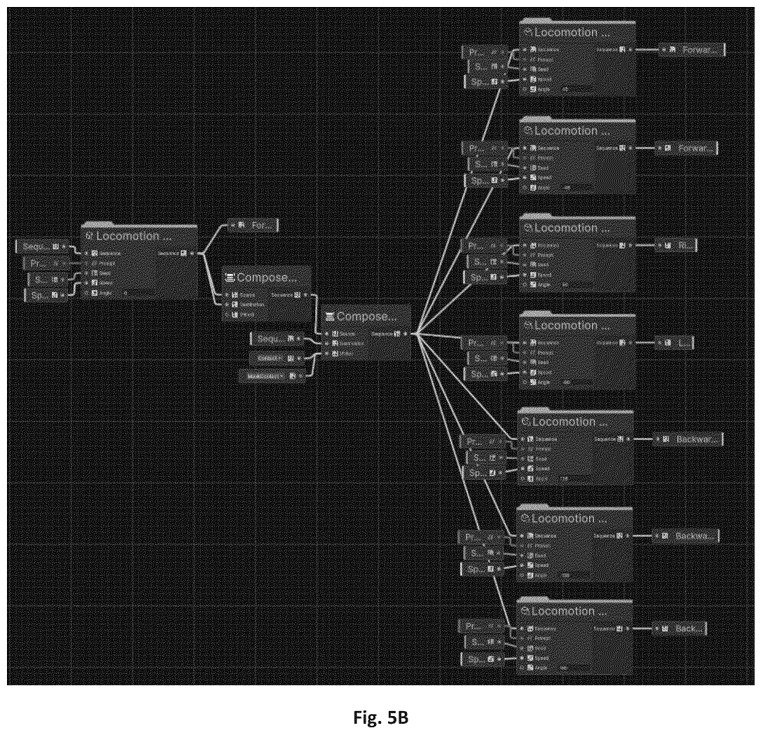

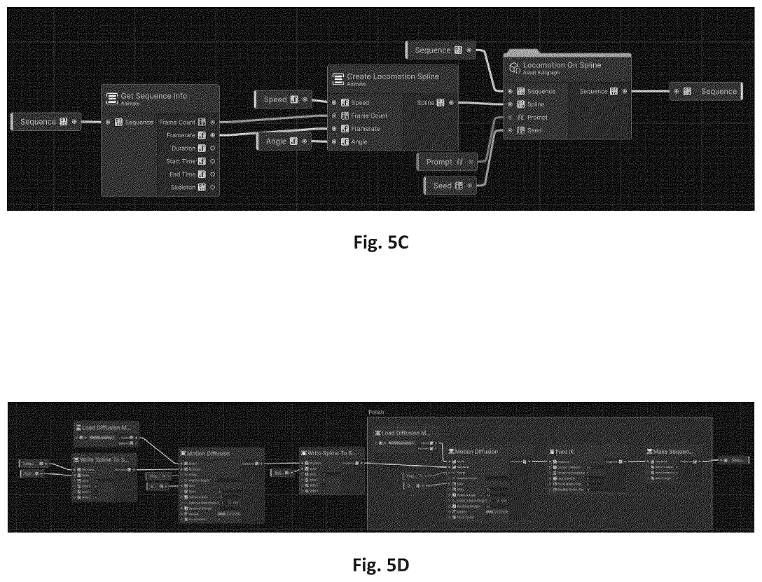

FIGS. 5A, 5B, 5C, and 5D depict a hierarchical sequence of nested graphs, each progressively refining and extending the locomotion animation generation process, from initial parameter configuration and motion data processing to detailed synthesis and final optimization of character movements.

FIG. 5A represents the top-level or parent graph in the sequence of nested graphs. This graph serves as the primary interface for initiating and configuring the locomotion generation process. It is responsible for collecting user-defined parameters such as the desired speed, style, or direction of movement. These parameters may set one or more foundational conditions for the animation sequences that will be generated. The parent graph orchestrates the overall flow of data and commands, ensuring that the initial configurations are correctly established and passed down to the subsequent graphs for further processing. This graph may act as a control panel, allowing users to start, monitor, and adjust the generation process based on the initial inputs.

FIG. 5B is called by Graph 1 and handles more specific aspects of the locomotion process but still operates at a relatively high level within the system. This graph deals with the initial processing of motion data, applying preliminary transformations, or setting up conditions for more detailed motion synthesis. It refines the input parameters received from Graph 1 and prepares the data for complex operations in the subsequent graphs. This includes preprocessing the motion data to ensure it is in the correct format and state for detailed synthesis and transformation in the later stages.

FIG. 5C, which is the third layer in the sequence, delves deeper into the motion creation process. Called by Graph 2, this graph focuses on generating specific motion sequences and handling intermediate computations that integrate a blend of input parameters and processed data. It includes algorithms or models that address the dynamics of motion, such as variations in speed or directional changes, ensuring that the motion sequences are dynamically responsive and accurately represent the intended movements. This graph may play a role in integrating dynamic elements into the motion, setting the stage for the final synthesis and optimization in the next graph.

FIG. 5D is the innermost graph in this nested structure and is called by Graph 3. It generates a first version of the animation using a motion diffusion model. It then forces the trajectory of the animation to the input spline since the diffusion model could have caused slight variation. A polish pass, in which the modified generation is further denoised to reduce foot sliding, additionally applies feet IK and ensures the animation is a perfect loop.

Each graph in this sequence adds a layer of complexity and refinement to the locomotion animation generation process, ensuring that the final outputs are detailed, responsive, and/or suitable for a high-quality gaming experience. The nested structure allows for modular adjustments and enhancements at various levels of the process, facilitating efficient and flexible animation production.

In example embodiments, a previous speed's forward motion to generate motion is leveraged for an additional, different (e.g., faster) speed, such as transitioning from walking to running. This figure depicts the system's ability to efficiently adapt existing motion data to different locomotion speeds, which may be usable for dynamic gameplay scenarios. In example embodiments, a visual comparison between the original motion trajectory at a walking speed and the adapted trajectory at a running speed may be provided. It may display vectors indicating changes in speed and direction, alongside overlays that highlight differences in stride lengths and contact timings between the two speeds.

In example embodiments, the application of specific algorithms or models that facilitate the transformation of motion data is depicted. This may include time-scaling techniques that adjust the duration of contact phases and stride lengths to suit the different speed, ensuring that the motion remains realistic. Additionally, interpolation and smoothing techniques may be depicted to maintain fluidity in the motion despite significant changes in speed. Adjustments in control signals, which govern aspects like foot, may also be shown to accommodate the increased speed. These adjustments may be usable for maintaining realism, preventing unnatural movements and animation artifacts.

FIG. 5 highlights the ability to repurpose existing animations for new speeds, thereby reducing the need to create new animations from scratch for each speed variation, saving both time and computational resources. Moreover, the figure underscores the system's advanced capability in producing realistic animations that can be finely tuned to different gameplay dynamics. The ability to dynamically adjust animations based on gameplay requirements enhances the player's experience by providing more responsive and engaging character movements.

In example embodiments, the order of various operations may be modified. For example, contacts erosion could be applied before time rescale.

In example embodiments, number of manual steps and manipulation required by the user to create locomotion sets is significantly reduced. For example, the need for animation expertise for generating such motion clips may be removed (e.g., by automating the generation, contact synchronization, path following, looping, speed adherence, and/or IK post-process from high level use inputs only).

In example embodiments, the AI models allow a text conditioning feature in the workflow of authoring locomotion sets.

For example, one or more AI models may be used for generating motion. Furthermore, the AI models may be combined with other automated operations on animation clips working around these AI models to complete the processing.

Thus, unlike prior art systems, the disclosed system and method may generate locomotion sets from high-level inputs (e.g., like the text prompt and speed).

In example embodiments, the final outputs are individual animation clips that are compatible together to create a locomotion set. Such output format makes it so that games developed (e.g., using a development platform, such as Unity) using character controllers may use the disclosed operations, without modification, in their game development to create one or more source clips for their locomotion sets.

In example embodiments, the disclosed system and methods provide iterations over parameters of the motions, such as the style, and/or the speed, at a significantly faster rate than prior art systems, without having animators needing to modify motions by hand.

In example embodiments, the disclosed system and methods fit the current setup of game developers and don't impose big changes on the way to animate a character. It's simply a new, low risk option to generate one or more valid locomotion sets very fast, with control over the key aspects.

In example embodiments, the resulting animation clips are exported in an animation format, such as FBX, to allow users to (1) use the locomotion sets in other engines, and (2) manually fine-tune or clean up the motions in their favorite animation software.

In example embodiments, as discussed herein, the system may be conditioned on text, and can provide a large or infinite number of variations for any prompt.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

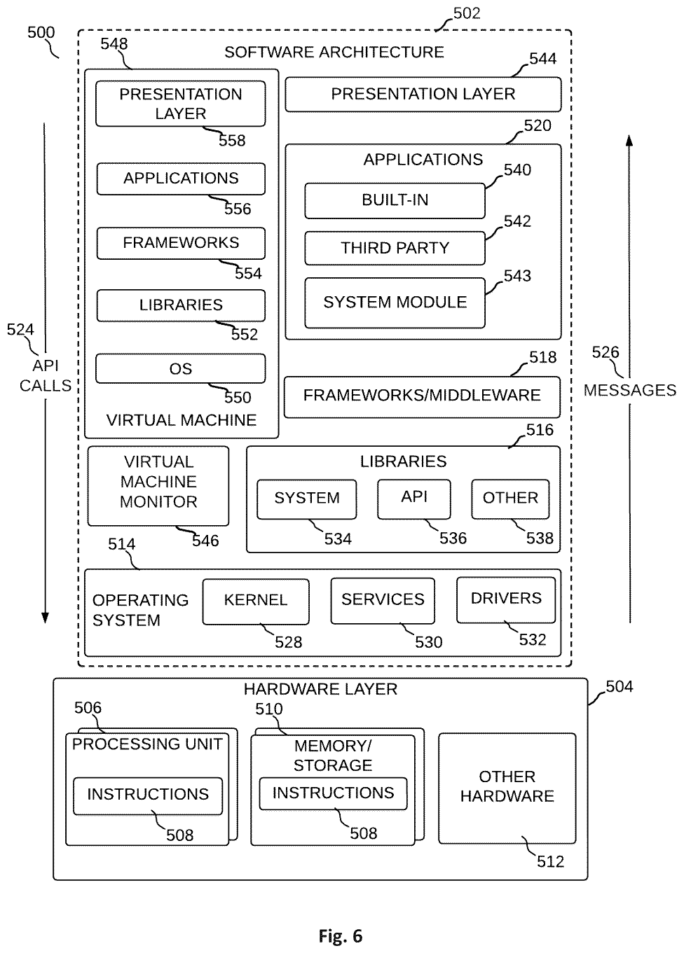

FIG. 6 is a block diagram 500 illustrating an example software architecture 502, which may be used in conjunction with various hardware architectures herein described to provide a gaming engine 501 and/or components of the rendering engine. FIG. 5 is a non-limiting example of a software architecture and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 1050. A representative hardware layer 504 is illustrated and can represent, for example, the machine 600 of FIG. 6. The representative hardware layer 504 includes a processing unit 506 having associated executable instructions 508. The executable instructions 508 represent the executable instructions of the software architecture 502, including implementation of the methods, modules and so forth described herein. The hardware layer 504 also includes memory/storage 510, which also includes the executable instructions 508. The hardware layer 504 may also comprise other hardware 512.

In the example architecture of FIG. 6, the software architecture 502 may be conceptualized as a stack of layers where each layer provides particular functionality. For example, the software architecture 502 may include layers such as an operating system 514, libraries 516, frameworks or middleware 518, applications 520 and a presentation layer 544. Operationally, the applications 520 and/or other components within the layers may invoke application programming interface (API) calls 524 through the software stack and receive a response as messages 526. The layers illustrated are representative in nature and not all software architectures have all layers. For example, some mobile or special purpose operating systems may not provide the frameworks/middleware 518, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 516 may provide a common infrastructure that may be used by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 616 may include system libraries 534 (e.g., C standard library) that may provide functions such as memory allocation functions, string manipulation functions, mathematic functions, and the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 516 may also include a wide variety of other libraries 538 to provide many other APIs to the applications 520 and other software components/modules.

The frameworks 518 (also sometimes referred to as middleware) provide a higher-level common infrastructure that may be used by the applications 520 and/or other software components/modules. For example, the frameworks/middleware 518 may provide various graphic user interface (GUI) functions, high-level resource management, high-level location services, and so forth. The frameworks/middleware 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 542 may invoke the API calls 524 provided by the mobile operating system such as operating system 514 to facilitate functionality described herein. In example embodiments, the applications 520 may one or more system module(s) 543. In example embodiments, any of the operations described herein, such as the operations described with respect to FIGS. 1-4, may be implemented by the rendering module 543. In example embodiments, the applications 520 may include one or more of the modules depicted in FIG. 1.

The applications 520 may use built-in operating system functions (e.g., kernel 528, services 530 and/or drivers 532), libraries 516, or frameworks/middleware 518 to create user interfaces to interact with users of the system. Alternatively, or additionally, in some systems, interactions with a user may occur through a presentation layer, such as the presentation layer 544. In these systems, the application/module “logic” can be separated from the aspects of the application/module that interact with a user.

Some software architectures use virtual machines. In the example of FIG. 5, this is illustrated by a virtual machine 548. The virtual machine 548 creates a software environment where applications/modules can execute as if they were executing on a hardware machine (such as the machine 600 of FIG. 6, for example). The virtual machine 548 is hosted by a host operating system (e.g., operating system 514) and typically, although not always, has a virtual machine monitor 546, which manages the operation of the virtual machine 548 as well as the interface with the host operating system (i.e., operating system 514). A software architecture executes within the virtual machine 548 such as an operating system (OS) 550, libraries 552, frameworks 554, applications 556, and/or a presentation layer 558. These layers of software architecture executing within the virtual machine 548 can be the same as corresponding layers previously described or may be different.

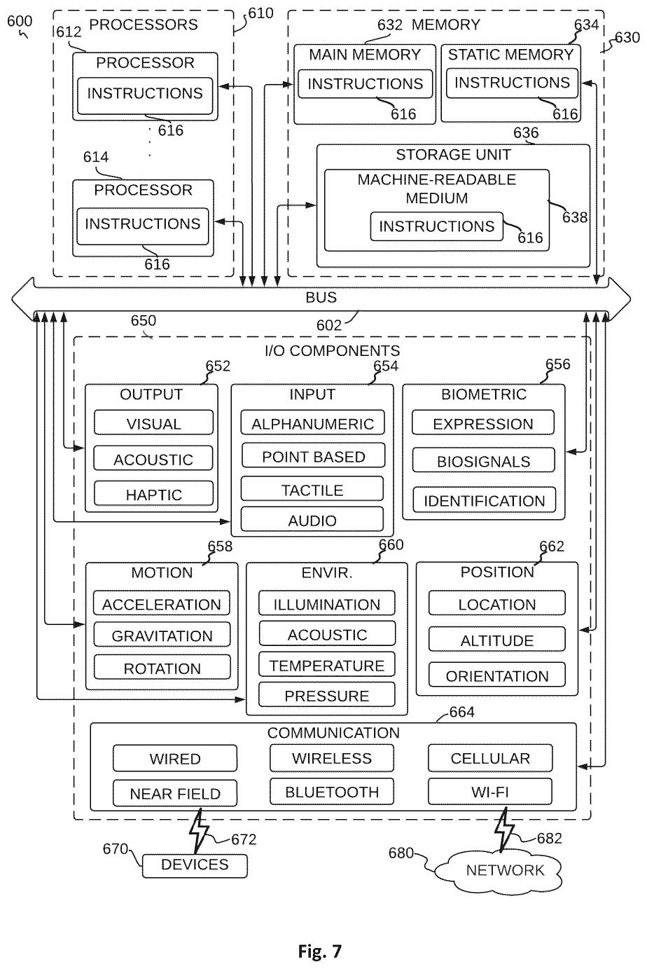

FIG. 7 is a block diagram illustrating components of a machine 600, according to some example embodiments, configured to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. As such, the instructions 616 may be used to implement modules or components described herein. The instructions transform the general, non-programmed machine into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines that individually or jointly execute the instructions 616 to perform any one or more of the methodologies discussed herein.

The machine 600 may include processors 610, memory 630, and input/output (I/O) components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that may execute the instructions 616. The term “processor” is intended to include multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core processor), multiple processors with a single core, multiple processors with multiples cores, or any combination thereof.

The memory/storage 630 may include a memory, such as a main memory 632, a static memory 634, or other memory, and a storage unit 636, both accessible to the processors 610 such as via the bus 602. The storage unit 636 and memory 632, 634 store the instructions 616 embodying any one or more of the methodologies or functions described herein. The instructions 616 may also reside, completely or partially, within the memory 632, 634, within the storage unit 636, within at least one of the processors 610 (e.g., within the processor's cache memory), or any suitable combination thereof, during execution thereof by the machine 600. Accordingly, the memory 632, 634, the storage unit 636, and the memory of processors 610 are examples of machine-readable media 638.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 650 may include a wide variety of components to receive input, provide output, produce output, transmit information, exchange information, capture measurements, and so on. The specific input/output (I/O) components 650 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 650 may include many other components that are not shown in FIG. 6. The input/output (I/O) components 650 are grouped according to functionality merely for simplifying the following discussion and the grouping is in no way limiting. In various example embodiments, the input/output (I/O) components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 650 may include communication components 664 operable to couple the machine 600 to a network 680 or devices 670 via a coupling 682 and a coupling 672 respectively. For example, the communication components 664 may include a network interface component or other suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 662, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

The term ‘content’ used throughout the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is understood to include any object of digital nature, digital structure or digital element within an environment. A digital object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application). For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

I/We claim:

1. A non-transitory computer-readable storage medium storing a set of instructions that, when executed by one or more computer processors, causes the one or more computer processors to perform operations, the operations comprising:
receiving one or more text inputs specifying movement style and base locomotion speed;
generating a forward motion clip using a first model that transforms a noisy sequence into a denoised, prompt-following motion with predicted foot contact states;
extending the forward motion clip to one or more additional motion clips via a second model that synchronizes the one or more additional motion clips to cover multiple directions based on the one or more text inputs and supports blending between the forward motion clip and the one or more additional motion clips based on one or more ground contacts; and
adjusting a locomotion set in real-time based on one or more user interactions or game scenario changes.

2. The non-transitory computer-readable storage medium of claim 1, wherein the generating of the forward motion clip further comprises using a diffusion model within the first model to refine the noisy sequence based on the one or more text inputs.

3. The non-transitory computer-readable storage medium of claim 2, wherein the diffusion model is configured to predict foot contact states and ensure a motion is synchronized with an intended path of a character in a gaming environment.

4. The non-transitory computer-readable storage medium of claim 1, wherein the extending of the forward motion clip to the one or more additional motion clips includes applying the second model to receive one or more additional control signals consisting of incomplete motion inputs and a corresponding mask.

5. The non-transitory computer-readable storage medium of claim 4, wherein the second model is trained to complete a missing motion received as input and synchronize the one or more additional motion clips with the forward motion clip to cover a full 360-degree range of motion directions.

6. The non-transitory computer-readable storage medium of claim 1, wherein the adjusting of the locomotion set includes implementing a feedback mechanism within a gaming environment that dynamically modifies one or more animation parameters of the locomotion set in response to one or more user inputs.

7. The non-transitory computer-readable storage medium of claim 6, wherein the one or more animation parameters include a speed, a direction, or a style.

8. A method comprising:
receiving one or more text inputs specifying movement style and base locomotion speed;
generating a forward motion clip using a first model that transforms a noisy sequence into a denoised, prompt-following motion with predicted foot contact states;
extending the forward motion clip to one or more additional motion clips via a second model that synchronizes the one or more additional motion clips to cover multiple directions based on the one or more text inputs and supports blending between the forward motion clip and the one or more additional motion clips based on one or more ground contacts; and
adjusting a locomotion set based on one or more user interactions.

9. The method of claim 8, wherein the generating of the forward motion clip further comprises using a diffusion model within the first model to refine the noisy sequence based on the one or more text inputs.

10. The method of claim 9, wherein the diffusion model is configured to predict foot contact states and ensure a motion is synchronized with an intended path of a character in a gaming environment.

11. The method of claim 8, wherein the extending of the forward motion clip to the one or more additional motion clips includes applying the second model to receive one or more additional control signals consisting of incomplete motion inputs and a corresponding mask.

12. The method of claim 11, wherein the second model is trained to complete a missing motion received as input and synchronize the one or more additional motion clips with the forward motion clip to cover a full 360-degree range of motion directions.

13. The method of claim 8, wherein the adjusting of the locomotion set includes implementing a feedback mechanism within a gaming environment that dynamically modifies one or more animation parameters of the locomotion set in response to one or more user inputs.

14. The method of claim 13, wherein the one or more animation parameters include a speed, a direction, or a style.

15. A system comprising:
one or more computer processors;
one or more computer memories;
a set of instructions incorporated into the one or more computer memories, the set of instructions configuring the one or more computer processors to perform operations, the operations comprising:
receiving one or more text inputs specifying movement style and base locomotion speed;
generating a forward motion clip using a first model that transforms a noisy sequence into a denoised, prompt-following motion with predicted foot contact states;
extending the forward motion clip to one or more additional motion clips via a second model that synchronizes the one or more additional motion clips to cover multiple directions based on the one or more text inputs and supports blending between the forward motion clip and the one or more additional motion clips based on one or more ground contacts; and
adjusting a locomotion set based on one or more user interactions.

16. The system of claim 15, wherein the generating of the forward motion clip further comprises using a diffusion model within the first model to refine the noisy sequence based on the one or more text inputs.

17. The system of claim 16, wherein the diffusion model is configured to predict foot contact states and ensure a motion is synchronized with an intended path of a character in a gaming environment.

18. The system of claim 15, wherein the extending of the forward motion clip to the one or more additional motion clips includes applying the second model to receive one or more additional control signals consisting of incomplete motion inputs and a corresponding mask.

19. The system of claim 18, wherein the second model is trained to complete a missing motion received as input and synchronize the one or more additional motion clips with the forward motion clip to cover a full 360-degree range of motion directions.

20. The system of claim 15, wherein the adjusting of the locomotion set includes implementing a feedback mechanism within a gaming environment that dynamically modifies one or more animation parameters of the locomotion set in response to one or more user inputs.
